(19) United States
(12) Patent Application Publication
(10) Pub. No.: US 2019/0171337 A1
(43) Pub. Date: Jun. 6, 2019

(54) METHOD OF DISPLAYING DATA FOR AIRCRAFT FLIGHT MANAGEMENT, AND ASSOCIATED COMPUTER PROGRAM PRODUCT AND SYSTEM

(71) Applicant: THALES, Courbevoie (FR)

(72) Inventors: Jean-Cédric PERRIN, VALENCE (FR); Fany BARAILLER, TOULOUSE (FR); Yannick LE ROUX, LE HAILLAN (FR); Patrick CAZAUX, LE HAILLAN (FR)

(21) Appl. No.: 16/093,577

(22) PCT Filed: Apr. 14, 2017
(86) PCT No.: PCT/EP2017/059045

§ 371 Date: Oct. 12, 2018

(30) Foreign Application Priority Data
Apr. 15, 2016 (FR) 1600634

(51) Int. Cl. G06F 3/0482; G06F 3/0484; G08G 5/00

(52) U.S. Cl. CPC G06F 3/0482; G06F 3/04847; G06F 3/013; G08G 5/0039; G06F 2203/04803; G06F 3/04845

(57) ABSTRACT

A method of displaying data for the management of the flight of an aircraft includes the steps consisting in receiving the selection of an object on a display screen present in the cockpit of the aircraft; determining one or more flight commands associated with the selected object; selecting at least one flight command from among the one or more determined flight commands; generating a display panel comprising a plurality of display tiles, one of the tiles displaying data associated with the selected object and another tile displaying the flight command selected. Developments describe the updating of the panel as a function of a revision of the flight plan, the displaying of attributes of a flight command, conditional display modifications, modalities of unfurling or of folding of the display tiles, the taking into account of the visual density of display, the use of display rules, in particular as a function of flight context.

### FIELD OF THE INVENTION

The invention relates to the technical field of man-machine interfaces for the flight management of an aircraft.

### PRIOR ART

The pilot of an aircraft is overburdened with information. Numerous avionics functions are at the disposal thereof when interacting for example with a navigation map or an interface managing the flight mission. A flight management system (or FMS) presents the pilot with a very large choice of functions. The man-machine interface (MMI), which renders these functions accessible to the pilot, constitutes in fact a critical aspect for good flight management and safety thereof. An appropriate man-machine interface can decrease the pilot's cognitive burden and thereby allow more effective piloting, improving flight safety.

The quantity of information to be displayed is increasing steadily, whilst the size of screens is hardly increasing, if at all. The pilot must then work with screens whose total surface area is limited whilst the MMI pages (for example the so-called “FPLN” flight plan page) are gaining in importance. The interactions proposed in current man-machine interfaces (MMI) are generally unitary and organized according to the architecture of the system (i.e. according to a situation of dependency with its components). They are in reality hardly optimized and generally not very intuitive (for example to perform several successive operations on one and the same element, an element must frequently be selected again after each operation).

Various display management solutions exist in avionics. The solutions with MCDU (“Multipurpose Control & Display Unit”) generally provide for a hierarchization of the functions across pages accessible from the “Functions Keys” and the “Line Select Keys”. This leads to a high number of pages, several information access layers and, above all, access which is not immediate for certain functions. Interactivity from the “Navigation Display” exists very rarely too. Generally, the graphical result is displayed on another screen (non-integrated solution). The ergonomics is in fact fairly limited, which does not facilitate decision taking.

Other known approaches as regards so-called MFD screens provide for interactivity being performed at the so-called ND Navigation Display (for example of FM Airbus A380, A350 type). The functions are hierarchized across the various pages managed by the FMS known by the acronym “FMD” (for FMS Displays), physical displays known to the person skilled in the art by the acronym “MFD” (for Multi Function Display), which pages are organized into tabs. Interactivity takes place at the ND (for example, access to a list of functions is provided by clicking on an element such as a waypoint of the ND; in return a high number of pages is displayed and the interactions are often limited to the visible elements alone). Nonetheless, there are still several information access layers and access is again no longer immediate for certain functions. Interactivity is not integrated, i.e. a plurality of screens is employed.

The patent literature specialized in the field of avionics (the constraints and demands as regards man-machine interface are specific to avionics) alludes to a few approaches as regards display management in contexts of significant visual density. Patent document US2013345905 entitled “Avionics display system providing enhanced flight-plan management” discloses according to the automatic translation of its abstract a method for executing a task associated with a flight plan displayed on a navigation screen in the form of a graphical image comprising the selection of the task, generating a symbology on the graphical display representing the task to be executed, characterized by at least one parameter, and the adjusting of at least one part of the symbology by dragging it over the screen to obtain a desired value of at least one parameter. This known approach presents limitations.

A need exists for advanced display methods and systems.

### SUMMARY OF THE INVENTION

The invention relates to a method of displaying data for the management of the flight of an aircraft comprising the steps consisting in receiving the selection of an object on a display screen present in the cockpit of the aircraft; determining one or more flight commands associated with the selected object; selecting at least one flight command from among said one or more determined flight commands; generating a display panel comprising a plurality of display tiles, one of the tiles displaying data associated with the selected object and another tile displaying the flight command selected. Developments describe the updating of the panel as a function of a revision of the flight plan, the displaying of attributes of a flight command, conditional display modifications, modalities of unfurling or of folding of the display tiles, the taking into account of the visual density of display, the use of display rules, in particular as a function of flight context.

Advantageously, the invention makes it possible to avoid the drawbacks of the modes of searching within complex tree-like menus (for which certain parameters must be input by the pilot in the systems initialization phase or in the course of flight mission).

Advantageously, the method according to the invention lightens the pilot's cognitive burden, leads qualitatively to better piloting decisions and quantitatively to faster actions in sometimes critical environments. The invention corresponds to a renewed logic of information organization, effective in terms of information presentation, of realization and of stringing together of the commands associated with the avionics functions.

Advantageously, the method according to the invention allows intuitive and efficient man-machine interaction which reduces workload. The number of actions for realizing a task (for example an FMS function) may be reduced.

Advantageously, the display density may be optimized. Man-machine interface learning is fast and does not require unwieldy and recurrent learning of the architecture of the pages or forms. Access to the various functions may be organized in a logical and coherent manner (e.g. lateral revisions of the FPLN, of the functions and of their attributes). Information presentation may consequently be more intuitive, more effective and more concise since it is controlled.

Advantageously, the structuring of information into “layers” (e.g. no structuring into menus and sub-menus) makes it possible to simultaneously display the set of possible actions or commands associated with an element (for example with a flight plan point), and to do so at the same “level”. This management of the data makes it possible to provide direct access to the various avionics functions and to do so in a minimum (quantitatively measurable by counting touchstrokes or cursor-based selections) of actions.

Advantageously, the method according to the invention makes it possible to decrease the risks of poor selections, because of possible poor interpretation or misunderstanding of a function (as may be the case when the functions are distributed among different windows).

Advantageously, the man-machine interface according to the invention makes it possible to perform successive revisions, without having to exit the tiled display panel.

Advantageously, the method according to the invention allows interactions on a not visible element (e.g. display zone too dense, element outside of the zone (range) displayed on the ND).

Advantageously, the man-machine interface according to the invention makes it possible to rapidly configure various parameters or attributes related to the element and/or the avionics function selected (for example the “Direct To” function making it possible to directly reach a point with an “Inbound course” parameter representing the angle of arrival at said point).

Advantageously, the display can be “dispersed” within the cockpit: the diverse screens present in the cockpit, depending on whether they are accessible or not, can be employed to distribute the information which must be displayed. Moreover, means of augmented and/or virtual reality can increase the display areas. Increasing the available display area does not render null and void the control of the display density allowed by the invention, via the display of one or more graphically selectable benchmarks. On the contrary, the (contextual) reconfiguration of the display aggregating this increase in the addressable display area and of control of the visual density (e.g. contextual concentration or densification) make it possible to significantly improve man-machine interaction.

Advantageously, the examples described facilitate the man-machine interactions and in particular unburden the pilot of sometimes repetitive and often complex tedious manipulations, at the same time improving his ability to concentrate on actual piloting. Defining a new man-machine interaction model, the best, and more intensive, use can be made of the pilot's visual field, making it possible to maintain a high level of attention or to best utilize the latter. The cognitive effort to be provided is thus optimized, or more exactly partially reallocated to more useful cognitive tasks in regard to the objective of piloting. Stated otherwise, the technical effects related to certain aspects of the invention correspond to a reduction in the cognitive burden of the user of the man-machine interface.

Advantageously, the invention can be applied in the avionics or aeronautical context (including drone remote piloting) but also in the automobile context and railroad or maritime transport contexts.

Advantageously, the invention can be implemented in or for or via so-called avionics systems (e.g. flight management systems, TAWS, RMS, Data link, Electronic Flight Bags or “EFB” installed in the cockpit) and/or one or more systems connected with the avionics systems (e.g. EFB of portable type).

### DESCRIPTION OF THE FIGURES

Other characteristics and advantages of the invention will become apparent with the aid of the description which follows and of the figures of the appended drawings in which:

FIG. 1 schematically illustrates the structure and the functions of a flight management system of known FMS type;

FIG. 2 illustrates an exemplary tiled display panel according to the invention;

FIG. 3 illustrates examples of steps of the method according to the invention;

FIG. 4 illustrates aspects of certain modes, in particular automated, of display management.

FIG. 5 illustrates embodiments of the method according to the invention which are performed in an automated manner.

### DETAILED DESCRIPTION OF THE INVENTION

To facilitate the understanding of the description of certain embodiments of the invention, technical terms and environments are defined hereinafter.

An “Electronic Flight Bag”, acronym or initials EFB, designates onboard electronic libraries. An “electronic flight bag” EFB, or “electronic flight tablet”, is a portable electronic apparatus used by flight personnel (for example pilots, maintenance, cabin etc.). An EFB can provide flight information to the crew, aiding them to perform tasks (with less paper). In practice, it generally entails an off-the-shelf computing tablet. One or more applications allow information management for flight management tasks. These general-purpose computing platforms are intended to reduce or replace the reference material in paper form, often found in the hand luggage of the “Pilot Flight Bag” and manipulation of which may be tedious. The paper reference documentation generally comprises the piloting manuals, the various navigation maps and the ground operations manuals. These items of documentation are advantageously paperless in an EFB. Furthermore, an EFB can host software applications specially designed to automate operations conducted manually in normal time, such as for example takeoff performance computations (computation of limit speed, etc.).

The acronym or initials FMS corresponds to the conventional terminology “Flight Management System” and designates the flight management systems of aircraft, known in the state of the art through the international standard ARINC 702. During the preparation of a flight or while rerouting, the crew undertakes the input of various items of information relating to the progress of the flight, typically by using an FMS aircraft flight management device. An FMS comprises input means and display means, as well as computation means. An operator, for example the pilot or the copilot, can input via the input means information such as constraints (e.g. overfly, altitude etc.) associated with waypoints, that is to say points vertically in line with which the aircraft must pass. These elements are known in the state of the art through the international standard ARINC 424. The computation means make it possible in particular to compute, on the basis of the flight plan comprising the list of waypoints, the trajectory of the aircraft, as a function of the geometry between the waypoints, the associated constraints and/or the altitude and speed conditions, and also the times of passage and fuel remaining at each point.

Hereinafter in the document, the acronym FMD is used to designate the display of the FMS present in the cockpit, disposed in general head-down (level with the pilot's knees). The FMD is organized as “pages” which are functional groupings of coherent information. Among these pages feature the “FPLN” page which presents the list of elements of the flight plan (waypoints, markers, pseudo waypoints) and the “DATA LIST” or “DUPLICATE” page which presents the results of the navigation database searches.

The acronym ND is used to designate the graphical display of the FMS present in the cockpit, disposed in general at head-level, i.e. in front of the face. This display is defined by a reference point (centered or at the bottom of the display) and a range, defining the size of the display zone.

The acronym MMI corresponds to Man-Machine Interface (or HMI for Human Machine Interface). The inputting of the information, and the displaying of the information input or computed by the display means, constitute such a man-machine interface. Generally, the MMI means allow the inputting and the consultation of the flight plan information.

The term “panel” designates a display surface (screen and/or projection surface) comprising several sub-parts, generally called “tiles”. The tiles can be passive (“reading” or “visualization” tiles) or else active (“interaction” or “navigation” tiles). The tiles are generally of regular geometric shape (e.g. squares, rectangles, triangles), but in certain embodiments they may be of irregular shape (tiling of the space or of the surface considered). The display panel is generally 2D (two dimensions, flat or curved) but sometimes 3D (the volumes can “unfold” into other data visualization volumes).

The term “element” designates any object of interest selectable and/or editable on the envisaged MMI. For example, an element can be a point of the flight plan (e.g. “flight plan fix”), one or more points in proximity to the flight plan (e.g. “nearest fixes”), an airplane or helicopter symbol, etc. An element can be a set of non-contiguous pixels of a display which is produced on a screen or a projection means.

The term “flight plan point” (or “waypoint”) designates in a generic manner a point according to the aeronautical standard ARINC A424 or according to a user database (i.e. a point defined by the pilot). This term designates for example an airport, a heliport, etc.

The expression “man-machine interface” (acronym MMI) designates physical means (screen and/or projection surfaces) of graphical representation and of interaction (for example touch-sensitive or haptic and/or via one or more media) with one or more avionics systems (and/or systems connected with the avionics), comprising a plurality of selectable elements. The tiled display panel according to the invention is encompassed within this avionics MMI environment.

Generally, a man-machine interface (MMI) allows good communication of the pilot with the onboard automatic systems. The MMI according to the invention allows management of the flight and of the mission. Such an MMI displays the information related to the mission and flight management system as various views: in the form of a navigation map (type ND—representation of the horizontal situation—horizontal view), and/or in the form of a flight plan and/or along a vertical axis (representation of the vertical profile of the flight plan) and/or along a temporal axis (sequential/temporal representation of the flight plan) and/or via a 3D view and/or any other representation of the flight, or of the flight plan or of the mission. The selectable elements are, as other, the elements included in the navigation database like the waypoints (including the waypoints of the flight plan and the “nearest fixes”), the beacons, etc., as well as the symbol representing the current position of the aircraft and any other element related to the flight or to the mission.

The expression “System in interaction” designates any avionics system (e.g. FMS, FWS, TAWS, etc.) or system connected with the avionics (e.g. EFB).

There is disclosed a method (implemented by computer) of displaying data for the management of the flight of an aircraft comprising the steps consisting in receiving an indication of the selection of an object on a display screen present in the cockpit of the aircraft; determining one or more flight commands associated with the selected object; selecting at least one flight command from among said one or more determined flight commands; generating a display panel comprising a plurality of display tiles, one of the tiles displaying data associated with the selected object and another tile displaying the flight command selected.

A flight command corresponds to the activation of an avionics function, for example within the flight management system FMS. For example, a command can be a so-called “overfly” command. More generally, a flight command corresponds to any action performed or instituted by the pilot.

A flight command can also be selected, i.e. received from the pilot. A flight command can be “preselected”, for example by the flight management system, the pilot confirming or otherwise this preselection if relevant.

Stated otherwise, there is generated a display panel comprising a plurality of display tiles (or banners), said tiles comprising for example a first tile displaying the identification of the selected object as well as one or more attributes associated with this object, a second tile displaying a list of commands (one or more of these commands being able to be preselected) and a third tile displaying a plurality of attributes and/or parameters and/or information associated with the selected command. In one embodiment, all the display tiles are displayed simultaneously: the selected element as well as the simple attributes and the possible commands are displayed according to one and the same “level” of information. In one embodiment, the display tiles are displayed progressively.

According to the invention, it is possible to modify the selection of an object once this object has been selected (folding in space of the display tiles as opposed to their unfurling in space). It is also possible to scan (“browse”) and search for elements not visible directly on the interface.

In a development, the method furthermore comprises a step consisting in determining a plurality of attributes related to the flight command selected.

Generally, a flight command may be associated with complementary data, which comprise “attributes”, that is to say “choices” and/or “options” and/or “parameters” and/or “information”. These complementary data may be determined or selected from among closed lists or open lists, may comprise thresholds and/or spans of thresholds. Certain data may be compulsory, others may be optional or discretionary. Certain data may change the state of the flight system if relevant, i.e. once input or entered (“active” data). The data may also comprise information which is not indispensable (annotations, metadata, etc.), i.e. “passive” data.

A flight command may be associated with one or more such attributes, required or optional.

These attributes may be computed, i.e. determined by the FMS for example, as a function of the flight phases or according to other considerations. Their determination may result from searches in databases and from diverse filtering and selection operations (in particular through the application of rules).

In a development, the method furthermore comprises a step consisting in determining an aircraft flight plan revision associated with the selected command and a step consisting in updating the content of one or more display tiles as a function of said flight plan revision.

In a particular case, the activation of a flight command may give rise to or enable a reconfiguration of the flight plan. If relevant, the flight plan may be revised, and this may in turn have consequences on the shape and/or the content of the tiled display panel.

In a development, the method furthermore comprises a step consisting in modifying the display of at least one attribute associated with the flight command selected as a function of the earlier selection of a flight command.

In one embodiment of the invention, the history of the flight commands selected by the system and/or by the pilot can influence the dynamics of rendition of the relevant attributes relating to a given command.

In a development, the method furthermore comprises a step consisting in modifying the flight command selected as a function of the earlier selection of a flight command.

In one embodiment of the invention, the command itself (not only one or more of its attributes) may be modified by authority of the machine or the FMS system. The command and/or one or more of the attributes may be modified. As described hereinabove, a modification may be triggered on account of an earlier selection of a flight command (predefined, i.e. from among predefined flight commands; commands may be incompatible, past commands may influence the choice of the future commands, etc.).

In a development, the display tiles are displayed in an adjacent manner in space and/or in a progressive manner over time.

In one embodiment, the tiles “unfurl” or “unfold” in an adjacent or contiguous manner in space (here 2D or curved). Each tile corresponds to a set of information which is homogeneous or at least inter-related (logic of “blocks” or of “plates”). The progressive addition of tiles, in all directions in space (around a first initial tile for example) makes it possible to propose a coherent logic in respect of the pilot's cognitive perception, i.e. by adding levels of detail while maintaining a certain history of the information presented. The total display area can therefore increase, by “spreading”, as a function of needs.

The tiling of space can be governed according to various modalities. In one embodiment, the tiles are parallelepipeds (e.g. squares and/or rectangles). In other embodiments, the tiles comprise triangular shapes. Other embodiments combine free shapes, circular or rectangular areas or any other tile shape so as to best tile the available space (when the tiles are projected onto available areas that may not necessarily be rectangular).

In one embodiment, the display tiles are substantially 2D. In certain other modes of display, the tiles are volumes in 3D.

The addition of information can be done by extending one or more display tiles. In a concurrent manner, the visual density of a display tile may be modulated (upwards or downwards).

The invention makes it possible furthermore to perform, in parallel or sequentially, commands on the basis of a plurality of elements (indeed, the unfurling in space of the various display tiles allows the pilot to perform various tasks; these various tiles if they do not overlap graphically can then allow the pilot to carry out mutually distinct actions).

In a development, the method furthermore comprises the step consisting in adjusting the shape and/or the content of the tiled display panel as a function of predefined display rules.

In a development, the display rules are determined as a function of the aircraft's flight context.

In a development, the display rules are determined as a function of the measured visual density of display.

In a development, the method furthermore comprises a step consisting in displaying the display panel on one or more screens in the cockpit of the aircraft.

In a development, the adjusting of the display or the display of the tiled display panel being deactivated on demand.

In a development, the method furthermore comprises a step consisting in receiving a message instructing that a display tile be closed or maximized or reduced.

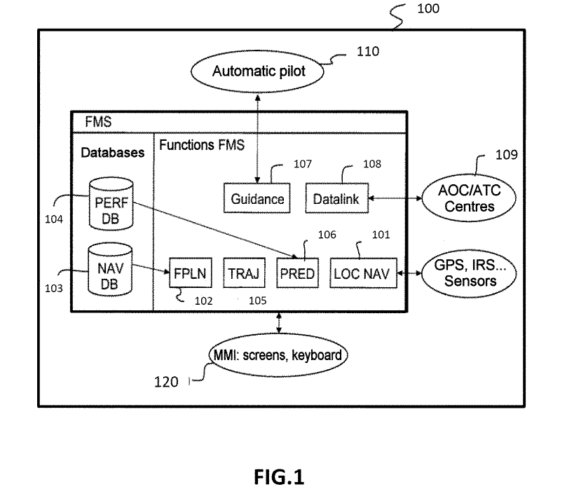

FIG. 1 schematically illustrates the structure and the functions of a flight management system of known FMS type. A system of FMS type 100 disposed in a cockpit has a man-machine interface 120 comprising input means, for example formed by a keyboard, and display means, for example formed by a display screen, or else simply a touch display screen, as well as at least the following functions:

Navigation (LOCNAV) 101, for performing optimal location of the aircraft as a function of the geolocation means 130 such as geo-positioning by satellite or GPS, GALILEO, VHF radionavigation beacons, inertial platforms. This module communicates with the aforementioned geolocation devices;

Flight plan (FPLN) 102, for inputting the geographical elements constituting the “skeleton” of the route to be followed, such as the points imposed by the departure and arrival procedures, waypoints, air corridors, commonly referred to as “airways”. The methods and systems described affect or relate to this part of the computer.

Navigation database (NAVDB) 103, for constructing geographical routes and procedures on the basis of data included in the bases relating to the points, beacons, interception or altitude legs, etc.;

Performance database, (PERFDB) 104, containing the craft's aerodynamic and engine parameters;

Lateral trajectory (TRAJ) 105, for constructing a continuous trajectory on the basis of the points of the flight plan, complying with the performance of the aircraft and the confinement constraints (RNP);

Predictions (PRED) 106, for constructing a vertical profile optimized on the lateral and vertical trajectory and giving the estimations of distance, time, altitude, speed, fuel and wind in particular over each point, at each change of piloting parameter and at destination, which will be displayed to the crew;

Guidance (GUID) 107, for guiding in the lateral and vertical planes the aircraft on its three-dimensional trajectory, while optimizing its speed, with the aid of the information computed by the Prediction function 206. In an aircraft equipped with an automatic piloting device 210, the latter can exchange information with the guidance module 207;

Digital data link (DATALINK) 108 for exchanging flight information between the Flight plan/Prediction functions and the control centers or other aircraft 109.

one or more screens, in particular the so-called FMD, ND and VD screens.

The FMD (“Flight Management Display”) is an interface, generally a display screen, that may be interactive (for example a touchscreen), making it possible to interact with the FMS (Flight Management System). For example, it makes it possible to define a route and to trigger the computation of the flight plan and of the associated trajectory. It also makes it possible to consult the result of the computation in text form.

The ND (“Navigation display”) is an interface, generally a display screen, that may be interactive (for example a touchscreen), making it possible to consult in two dimensions the lateral trajectory of the airplane, viewed from above. Various modes of visualization are available (rose, plan, arc, etc.) as well as according to various scales (configurable).

The VD (“Vertical Display”) is an interface, generally a display screen, that may be interactive (for example a touchscreen), making it possible to consult in two dimensions the vertical profile, projection of the trajectory. Just as for the ND, various scales are possible.

The set of information entered or computed by the FMS is grouped together on various display screens (FMD pages, ND and PFD “VDUs”, HUD (for Head-Up Display) or other, such as a screen fusing the set of information in a concept of integrated Man System interface). The MMI component(s) of the FMS structures or structure the data for dispatch to the display screens (termed CDS for Cockpit Display system). The CDS itself, representing the screen and its graphical piloting software, performs the display of the drawing of the trajectory, and also comprises the pilots making it possible to identify the movements of the finger (if touch-sensitive) or of the pointing device. Other architectures exist.

In one embodiment provided by way of example, the new revision according to the invention can be carried out in part by the MMI part, which displays the revision menu and calls the FPLN component which carries out the modification of the flight plan. Thereafter, the TRAJ and PRED components recompute the new trajectory and the new predictions, which are displayed by the MMI part. Other software architectures are possible.

In one embodiment, the method is implemented in a system comprising means of touch-based interaction and/or via one or more cursors.

In one embodiment, the system according to the invention comprises means of an avionics nature (i.e. certified or regulated systems such as flight management systems, TAWS, installed EFB, system for managing frequencies, etc.) and/or means connected with the avionics means (e.g. portable EFB, of tablet type).

The aircraft within the meaning of the invention can be an airplane, a helicopter, a drone, etc.

In one embodiment, the system according to the invention comprises a display screen (sometimes termed “panel”) placed at head-level (for example of Navigation Display or ND type) or else placed head-down. After selection (for example by a click with the cursor or a touch-based selection) of a selectable element, there is generated a specific display within the man-machine interfaces present in the cockpit of the aircraft whose context is updated.

In one embodiment, the various displays may be dispersed over the various physical display screens available in the enclosure of the cockpit. In one embodiment the display is termed “integrated”, that is to say is performed within the same display space as that of the selection. Display management rules can make provision for which information (or “types”) may be displayed, on which screens and at what time interval.

In one embodiment, the method according to the invention comprises in particular the step consisting in selecting (by a human and/or a machine) a graphical element (predefined as being selectable by means of the graphical interface), the step consisting in designating the action to be performed on the selected element and the step consisting in parametrizing the action to be carried out (for example, a parametrization will be able to include the selection of a second element to supplement the selected element).

In one embodiment, the method according to the invention allows the graphical selection of an element which is not visible prima facie, for example by using functionalities for discovering and/or for searching for elements previously associated with the elements presented in a visible manner.

In one embodiment, an element having been selected, a set of information associated with this element is displayed in a display panel comprising a plurality of display tiles. The various display tiles give access, in a direct and immediate manner, at a single glance, to the set of possible flight and mission related management functions pertaining to the selected element.

The information displayed in the various display tiles comprises raw data (passive) and/or zones (active), e.g. selectable icons, making it possible to parametrize yet more the element or the function selected. Advantageously, a man-machine interface designed according to the invention will make it possible to string together the revisions related to this initially selected element as well as to other elements of the flight plan or of the mission without having to exit the display panel according to the invention.

In one embodiment of the invention, the method is implemented in an MMI screen of avionics type, for example at the Navigation Display.

In one embodiment, one of the tiles of the display panel displays information and/or parameters complementary to the initial selection. For example, with a view to the insertion of a next flight plan point of “next waypoint”, it is possible to designate directly on the screen this flight plan point on the representation of the horizontal situation of the aircraft, or else, if the element is not visible, to use the tiled display panel by inputting its identifier into a search bar and/or by selecting this point from a proposed list. In one embodiment, information i.e. (factual) data relating to the active zone selected can be displayed (alone). In one embodiment parameters (for example configuration parameters) can also be accessed or modified. In one embodiment, factual data and configurable parameters can be displayed (and optionally selected).

In one embodiment of the invention, the display density (“informational density” or “density of information”) can be (manually and/or automatically) adjusted. The adjusting of the display density may in particular be performed as a function of the flight context (e.g. the phases of takeoff, cruising, etc. justify possibly different display modalities).

The adjustment of the display can also take account of the intrinsic configuration of the cockpit. For example, the mechanism for adjusting the display density can take into account the side on which the pilot is situated in the cockpit of the aircraft (i.e. if the flight commands are managed on the left side, the information on the displays on this same side will be more summarized so as to decrease the informational density and the masking of the operational situation).

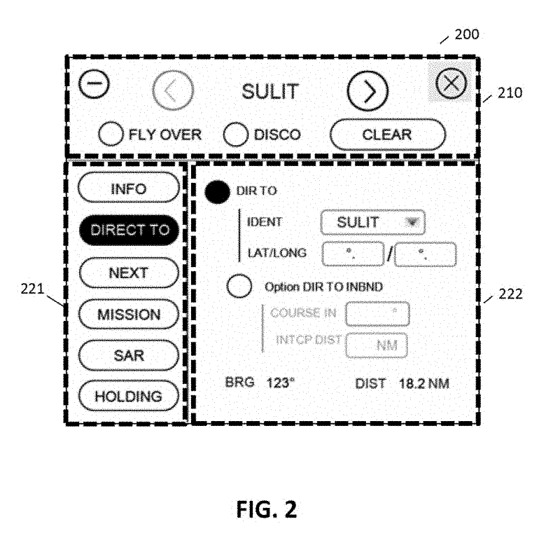

FIG. 2 illustrates an exemplary tiled display panel in an embodiment of the invention. The example shows three tiles (210, 221 and 222). Each tile can be read-mode and/or write-mode (reading versus navigation). In the example, the tile 210 is a navigation tile (interactive), the tile 221 is a selection tile, and the tile 222 is a reading/writing tile for selecting parameters of a function activated in the tile 221.

In one embodiment, the display panel comprises a plurality of display tiles (for example two, three or many more, such as some ten tiles). Stated otherwise, and according to certain embodiments, the interface according to the invention defines man-machine interfaces which are i) invocable on request, ii) which can use in an opportunistic manner the display and/or projection spaces available in the space close to the pilot (virtual and/or real spaces), iii) these interfaces being “unfoldable” according to various depths or layers (the graphical unfolding being predefined and/or dynamically computed).

In one embodiment, the display tiles may be mutually independent. In one embodiment, the tiles may be interdependent (the updating of one display tile may for example give rise in cascade to the updating and/or the opening of other display tiles). In certain embodiments, certain display tiles may be independent while others may be interdependent (i.e. according to the connectedness of the graph defining the dependencies between the display tiles).

In one embodiment, one or more tile display tiles may be associated with a predefined priority of display and/or inherited from the priority of the associated information item and displayed in the tile considered. For example, a severe meteorological condition may require a minimum display area, regardless moreover of the other current displays in progress. The display priorities may be absolute (if relevant) or relative (i.e. contextual).

In one embodiment, one or more display tiles may be associated with one or more access rights (e.g. configured by the airline). The display of a display tile may therefore be conditionally permitted.

The opening (or displaying) of tiles can be performed in various ways. The display of one or more tiles can be performed by extension (i.e. gain of area gained to the detriment of a pre-existing display for example). The display of one or more tiles can be performed by regression or involution or compacting or by the densification of one or more other tiles (e.g. unfoldings, foldings, superposition, subtraction, fusion, modification of the size of the font, etc.).

The tile 210 illustrated in the upper zone of the display panel 200 displays data associated with the selected element (for example the element currently being edited). In one embodiment, it has, for certain elements, navigation arrows making it possible to choose another element of the same type (e.g. for the waypoints belonging to the flight plan, the display tile has navigation arrows making it possible to select another waypoint of the flight plan). The tile 210 optionally comprises selectable elements making it possible to manage the display (for example an icon for closing the display panel, selectable icons for reducing or magnifying the display, or reducing the number of tiles displayed). This zone can correspond to the contextual information display zone and can in particular contain one or more complementary and/or additional “widgets” making it possible to define attributes of the selected element and/or simple actions or commands (for example, in the case of an interaction with the FMS, an “OVERFLY” command, i.e. an overflying of the element, a “DISCO” command, i.e. the deletion/insertion of a flight plan discontinuity following the element, a “CLEAR” command, i.e. the deletion of the waypoint).

The display tile 221 illustrated in the lower left zone of the display panel 200 can list for example the parametrizable commands which are applicable to the selected element. In the case of an interaction with the flight management system, this display tile makes it possible to select a function of the flight management system FMS from among those possible associated with this element (for example, the INFO function, i.e. access to the information on the element, the DIR TO function, i.e. flight direct to the element, the NEXT function, i.e. insertion of an element after the element etc.). Some of these avionics functions necessarily require parametrization. Other avionics functions may optionally benefit from parametrization.

The display tile 222 illustrated in the lower right zone of the display panel 200 may in particular detail the parameters (or “attributes” or “options”) of the chosen or selected command. In the case of interaction with the FMS, this may entail parametrizable attributes corresponding to the chosen function, including the selection of a supplement element necessary for the function (for example the NEXT function which requires the identification/selection of the element to be inserted after the selected element).

In a variant embodiment, so as in particular to optimize the display density, the display panel can propose two different representations (alternative or successive): a so-called “reduced” display mode and a so-called “full” display mode. The reduced display mode corresponds to the display of the upper zone 210 alone. The full or extended display mode corresponds to the display of the three display tiles.

The switch from one mode of display to another is generally triggered on request, in a manual manner (e.g. via interactive icons or symbols indicative of the actions such as reduce or magnify). In certain embodiments, toggling from one mode of display to another can be triggered automatically, i.e. according to predefined criteria. These predefined criteria may in particular be determined a) as a function of graphical or visual criteria such as for example the size of the horizontal situation displayed (for example according to the percentage of masking of the horizontal situation by the panel, b) as a function of the necessity or otherwise to parametrize the selected function or c) of other criteria (described hereinafter) such as the flight context and/or the visual density of the display, measured in the cockpit.

For example, by default, the display panel can be displayed in its reduced mode and then be displayed in its extended mode when the context requires it or justifies it (for example if text input is required). The return to a n′display in reduced mode can thereafter allow better visualization of the result on the horizontal situation. The switch from one mode to another thus corresponds to particular mission contexts or scenarios, which may be predetermined.

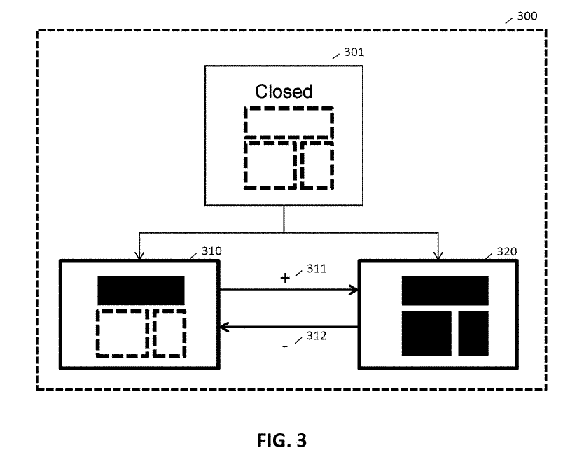

FIG. 3 illustrates the management of the display of an exemplary tiled display panel according to the invention.

The management of the states of the tiled display panel 300 can be performed in various ways.

In one embodiment, the display panel in an initially closed state 301 (not visible) is open or displayed in a so-called “reduced” or “semi-open” state 310.

Various modalities of opening (“unfolding”, “unfurling”) are possible, corresponding to different trigger facts and/or triggering rule. In one embodiment, the triggering of opening is obtained by voice command. In one embodiment, opening or unfolding is determined subsequent to the selecting of an element on the touch interface (for example when the pilot selects a flight plan point). In one embodiment, the display panel is opened subsequent to the selecting of a particular option in an external system (for example from in a menu outside the display panel). In one embodiment, unfolding is carried out automatically, as a function of predefined criteria. In one embodiment, unfolding is proposed on the basis of predefined criteria and the unfurling remains on standby awaiting confirmation of opening by the pilot (e.g. indication of a possible unfolding by highlighting, blinking, icon display, etc.)

In one embodiment using projection means (pico-projectors, augmented and/or virtual reality), the actual site of the display can be determined on request (for example, the pilot can designate in space a site in the cockpit free of display (within the display screens but also outside them). In this way, in a specific embodiment, the method according to the invention allows the opportunistic, flexible and contextual display of information on any surface at the pilot's choice, the opening of the various display tiles being able to optimize the areas available. Coupled with gaze tracking means, the cognitive attention of the pilot can then be utilized in an optimal manner.

In one embodiment, a semi-open state of the tiled panel 310 may for example comprise a list of possible actions (comprising for example favorite actions or commonly used actions or else actions that the pilot might choose).

The selection of one of the actions thus listed may give rise if relevant to the “complete” opening of the interactive panel in a state 320.

In certain cases, if the selected action corresponds to one of the predefined actions of the display panel, the corresponding tab is then displayed during the opening of the panel.

In certain situations, an action may be preselected (i.e. selected and on standby awaiting confirmation by the pilot.

Stated otherwise, certain actions are complete by nature while other actions require the entry of additional data or the selecting of options. The display panel may open in reduced (or full) mode as a function of the necessity or otherwise to parametrize said action associated with the selected element.

For example, the display panel may open in reduced mode when the system proposes a result based on default parameters. The switch to full mode will then make it possible to overload these parameters

The panel will also be able to open in full mode when the system requires an input in order to be able to propose a result. Switching to reduced mode will then allow better visualization of the result on the horizontal situation.

Generally, after the selecting of one or more elements, one or more actions to be performed on the selected element or elements are indicated in a declarative manner and/or are determined by computation. Once an element has been selected, a display tile is opened or displayed, presenting the set of possible parameters or actions associated with this element.

In one embodiment, the method is implemented in or in conjunction with a flight management system FMS. The selecting of one of the commands can then give rise to the updating of the flight plan (creation or modification of the temporary flight plan), which revision can be instantaneously transferred graphically into the display panel.

In one embodiment, the display panel can coexist with direct interactions exerted by the pilot as regards piloting (e.g. in horizontal view).

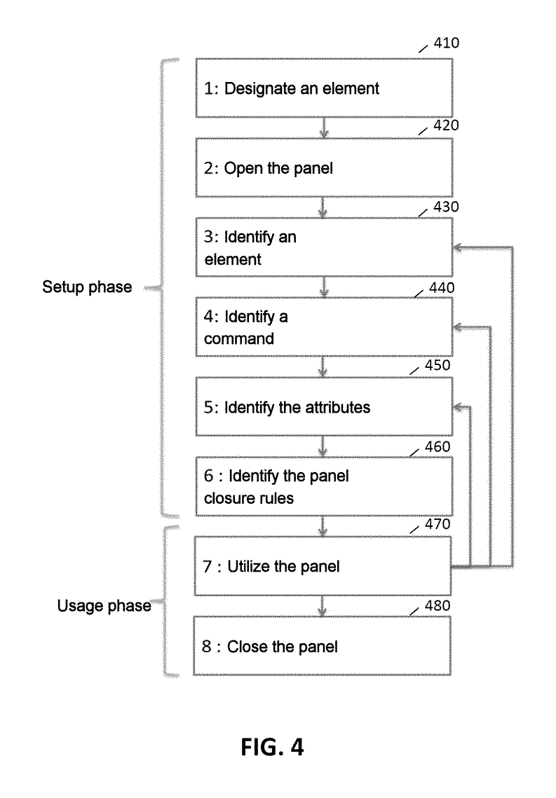

FIG. 4 illustrates examples of steps of the method according to the invention.

In a first step 410, at least one element is designated (or indicated or determined), for example by means of a selection from among the elements displayed on a display screen, in the form of a list for example. Such a list can be configurable. It can be configured by the pilot and/or the airline. The listed elements can in particular comprise navigation elements arising from an aeronautical database (“waypoints”, “navaids”, airports, heliports, etc.), navigation elements belonging to the flight plans (active, temporary, secondary) and arising from an FMS facility, elements in conjunction with the symbolic representation of the aircraft in the avionics MMI formulated on the basis of the airplane's geolocation facilities (e.g. ADIRS or GPS), points of geographical benchmarks positioned by the crew on a map (e.g. “markers”), air traffic elements arising from a facility of aerial transponder type (TCAS/ADSB), maritime traffic elements arising from a facility of maritime transponder type (AIS), or else symbolic representations of the sighting points and zones of coverage of video sensors arising from a facility of Electro Optical System type, elements relating to navigation (e.g. “airways”, “airspaces”, departure procedures, arrival procedures, etc.), general mapping elements (e.g. indications of roads, rivers, towns, obstacles) and/or airport elements (e.g. “taxiway”, “runway”, “gates”, etc.).

Designation of an element can be done directly graphically or via a search for this element (e.g. “search IDENT”). The designation of an element can be associated with a command via a menu associated with this element. Designation can be performed on any type of visualization (e.g. geo-referenced horizontal view, vertical view, view along a temporal axis, 3D view, etc.).

Designation can be performed by touchscreen, cursor, keyboard, mouse, gaze tracking, voice command, haptic feedback, etc. (or according to a combination of these means).

In a second step 420, the display panel can open in a full or reduced mode state, for example according to the element or the action selected (e.g. parametrizable action), or according to the flight context (e.g. the state of the cockpit and of the display zone allocated to the flight and mission management MMI, these states being able to vary in the course of mission). For example, if the avionics MMI has a sufficient display zone, the panel can open entirely. If the state of the cockpit makes it necessary to constrain the display zone of the flight and mission management MMI, then the panel can open in a reduced manner.

By way of example, the tiled display panel can open in “full” mode when the flight and mission management MMI has a display zone whose diagonal is greater than or equal to fifteen inches. By default, the tiled display panel will be displayed in its reduced mode.

In order to prevent the tiled display panel from hiding an important item of information, the pilot can at any moment decide to modify the state of the tiled display panel (from extended to reduced or vice-versa). The pilot can also move the tiled display panel over the various man-machine interfaces.

In a third step 430, the selected element is identified. For example, as a function of the element selected in the first step, the tiled display panel opens while identifying by a text the element of interest in the upper zone of the tiled display panel. Subsequent to this, a logic for changing selected element is implemented in the panel in the following manner: several logics for changing selected element are defined statically during the design of the flight and mission management MMI; a logic for changing selected element is chosen dynamically during the identification of the element, as a function of its type; the implementation of the logic for changing is carried out dynamically since it is related to the current state of the facilities connected with the avionics MMI.

By way of example, for a flight plan element which is not the last point of the flight plan, the pilot can at any moment select the following element in the flight plan via a navigation arrow (e.g. a “before” arrow). For a flight plan element which is not the first point of the flight plan, the pilot can at any moment select the previous element in the flight plan via a navigation arrow (e.g. a “return” arrow). In one embodiment, navigation may be circular between the various elements (i.e. no blocking on the first and last elements).

In one embodiment, the selection of an element which is not selectable prima facie (for example which does not belong to the flight plan) can also determine the selection of another element, for example the selection of a geographically close element, of an element present at the same altitude level, of an element of the same type (e.g. from beacons to beacons), previous/following point of the selected airway, etc.

In a fourth step 440, a command is determined and applied to the element selected in the previous step or resulting from the previously activated command. In order to identify the commands displayed in the lower left zone of the panel, several steps can be implemented. For each type of selectable element, a list of possible commands on this element can be defined statically during the design of the flight and mission management MMI. The validity of each command can then be determined dynamically, for example as a function of the state and of the validity of the facilities connected with the avionics MMI (FMS, RMS, BDD, TCAS, etc.), or according to the characteristics of the flight plan segment (“leg”), of the pattern or of the procedure containing this element, etc. The list of commands displayed in the lower left zone of the panel can also be formulated dynamically, for example as a function of the selected element, of its type, of its membership (e.g. “active FPLN”, “secondary FPLN”, “approach pattern”) and/or of the various validities of the associated commands. In one embodiment, the selection of a command from among all those displayed can be determined dynamically. For example, this determination can take into account the command which it was possible to identify when selecting the element during the first step. Optionally, priorities associated with the various commands can be predefined (for example during the design of the MMI). In certain embodiments, the crew or the pilot has the ability to dynamically select another command from among those available on the selected element.

By way of example, the possible commands can comprise one or more of the commands comprising the overflying of the element (“OVERFLY”), the deletion or the insertion of a flight plan discontinuity following the element, the deletion of the element, the modification of the parameters of the selected element, access to the information associated with the selected element, flying direct to the selected element (“DIRECT TO”), the insertion of an element (point) after the selected element, the insertion of a mission section on the basis of the selected element, the insertion of a holding “pattern” on the selected element, the insertion of a landing/takeoff “pattern” on the selected element, the selection of a communication frequency associated with the selected element, the selection of a navigation frequency associated with the selected element, the consultation of the terminal maps associated with the selected element, or still more generally any possible type of command on said selected element (e.g. insertion of patterns of SAR type).

In one embodiment, in a dynamic manner, if the FMS avionics facility does not make it possible to insert a mission on a flight plan point (for example when the flight plan already integrates a mission), the command “insert a mission pattern on the element” may be rendered invalid (unselectable, grayed out, inactive). If the radio navigation management facility does not permit any change of frequency, the command “select a navigation frequency associated with the element” is rendered invalid under the same conditions.

In one embodiment, one or more commands may be preselected. For example, if the selection of the element in the first step was performed directly, a preselected command may be for example “access to the information on the element”. If the selection of the element was performed via a menu with an insertion command, the preselected command may be for example “insertion of a flight plan point after the element”. This preselection does not, however, prevent a change of command.

In a fifth step 450, the attributes associated with a command are determined. Generally, a command is associated with a plurality of attributes. These attributes can be displayed in the lower right zone of the panel. The attributes can be defined as follows. For each command, a list of compulsory parameters and a list of optional parameters can be defined statically during the design of the flight and mission management MMI. For each attribute, the facility being able to receive the command provides the flight and mission management MMI dynamically with the current value of the attribute in the system, or with a default value if the attribute does not yet have a defined value. The crew has the possibility of choosing the attribute that it wishes to modify. As a function of the attribute, the modification can be made directly (ON/OFF change) or by selecting an element from a list or by inputting a value (alpha/numerical) or with the aid of a rotator (e.g. increase/decrease the value). For example, the command “delete the element” might not have any compulsory attribute nor even any optional attribute. The command “overfly the element” may have a compulsory attribute (either ON or OFF). The command “fly direct to the element” may have a compulsory attribute (ON or OFF with three optional attributes, for example “Inbound ON/OFF, Inbound Course value, Intercept distance value”. The compulsory parameters may be initialized with default values by the system so as to improve the operational effectiveness thereof. If need be, the pilot may modify the default values.

In a sixth step 460, the rules for managing the display of the display panel may be determined (these closure conditions or rules may be configurable and therefore configured). The panel closure rules may be of a general nature (that is to say applicable to any type of selected element) or else be specific (that is to say particular to a type of selected element, for example according to the third step, or to a command in progress, for example according to the fourth step). The list of general and specific closure rules can be defined statically during the design of the flight and mission management MMI. The application of the rules can be done dynamically during the use of the MMI. By way of example, the overall shutdown of the MMI can give rise to the closure of the panel (for any type of element). The direct, and therefore intentional, command of the crew for closure of the panel likewise gives rise to the closure of the panel. By way of specific example, if the selected element belongs to a temporary flight plan, the validation or the cancelation of the flight plan gives rise to the closure of the panel. Generally, predefined logic rules can govern the panel display modes and/or the transitions between these various modes.

In a seventh step 470, the panel as such is displayed and “utilized” (according to the modalities determined hereinabove, i.e. its shape and its content being determined). Advantageously, the various possibilities of utilization are available simultaneously, thereby offering the crew flexibility and effectiveness in stringing the commands together (e.g. setup, update, new command, etc.).

Several scenarios are described by way of example hereinafter.

To modify a command attribute, the pilot can use the lower right zone of the panel or the upper zone of the panel. The effect of this action is to dispatch a command to the facility in charge of this attribute. The facility then processes the command and generates a result. This result is visible in a conventional manner on the views of the flight and mission management MMI. The result is also visible in a dedicated manner in the panel. This gives rise to the return to the fifth step 450 (identification of the attributes) and updates the attributes by the facility. For example, by modifying the “Fly over” attribute, the FMS facility updates the value of the state of the “Fly over” attribute after taking the command into account.

To change a command, the pilot can use the lower left zone of the panel (or optionally the upper zone of the panel for a simple command with no attributes). The effect of this action can be to change the command in progress on the element. The panel repeats step 440 (“identification of a command”). For example, if the command “fly direct to the element” is in progress, the crew can choose to select the command “access the information”.

To change or modify a previously selected element, the pilot can use the upper part of the panel. This action can consist, for the crew, in using the change-of-element logics identified in the third step 430 (identification of the element). The effect of this action can be to repeat step 3.

To close the panel, the pilot can activate one of the logics of step 460. If relevant, this action gives rise to the realization of the actual closure step 480 (closure and end of utilization). The configuration file is not necessarily accessible to the pilot (it may be managed by the airline). In one embodiment, the pilot can perform one of the possible actions according to one of the logics (from among those described in step 460), and this may give rise to the closure of the display panel.

At any moment, the pilot can return to the panel and trigger the implementation of the previously described sequence of steps (or variants).

In a particular embodiment, the method comprises the steps consisting in receiving the indication of an object selected on a display screen of the aircraft; carrying out the opening of the panel (in full or reduced mode); constructing the upper cartouche via the information of the selected element; constructing the list of commands and preselecting a command; determining the attributes related to the preselected command; determining panel closure rules; determining a revision type associated with the revision displayed and selected, and updating the panel having regard to the revision.

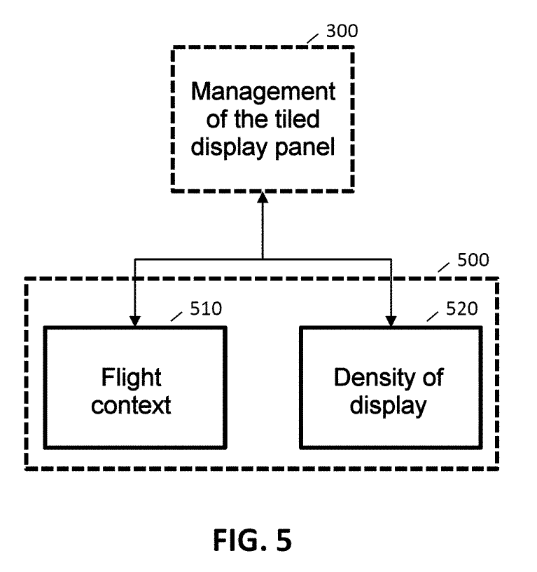

FIG. 5 illustrates embodiments of the method according to the invention which are performed in an automated manner.

The management of the states of the tiled display panel 300 can be performed in various ways. It can be configurable. The management can be modulated or regulated by applying display rules 500.

The display modalities can therefore be controlled by applying display rules 500 in respect of the tiled display panel, these rules being able in particular to take into account display priorities (absolute or relative, i.e. resolving conflicts between priorities of the same level).

Stated otherwise, the pilot can preselect the information that he wishes to see displayed, either exclusively (i.e. in a binary manner) or in a priority manner. The pilot can decide which elements are judicious from among all those available. By selecting or by activating certain display options the pilot can maximize the relevance of the information rendered accessible. In a variant embodiment, the display modalities are preconfigured by the airline. In another variant, the flight context evaluated repeatedly over time determines said display modalities dynamically.

In particular, the management of the tiled display panel 300 can be modulated or regulated by determining (declaratively and/or by computation) the flight context 510 that the aircraft is in and/or (i.e. as a supplement or in substitution) by taking into account the visual density of the display 520.

In certain embodiments of the invention, the method comprises steps or logical methods making it possible to determine the “flight context” or “current flight context” of the aircraft.

The flight context at a given moment integrates the mission in progress or planned, the set of actions taken by the pilots (and in particular the actual piloting settings) and the influence of the exterior environment on the aircraft.

A “flight context” comprises for example a situation from among predefined or pre-categorized situations associated with data, such as the position, the flight phase, the waypoints, the procedure in progress (and others). For example, the aircraft may be in the approach phase for landing, in the takeoff phase, in the cruising phase or may also be ascending or descending in stages, etc. (a variety of situations can be predefined). Moreover, the current “flight context” may be associated with a multitude of attributes or of descriptive parameters (current meteorological state, state of the traffic, status of the pilot comprising for example a stress level such as measured by sensors, etc.).

A flight context can therefore also comprise data, for example filtered by priority and/or based on flight phase data, meteorological problems, avionics parameters, ATC negotiations, anomalies related to the status of the flight, problems related to the traffic and/or to the relief. Examples of “flight context” comprise for example contexts such as “cruising regime/no turbulence/nominal pilot stress” or else “landing phase/turbulence/intense pilot stress”. These contexts can be structured according to diverse models (e.g. hierarchized for example as a tree or according to diverse dependencies, including graphs). Categories of contexts can be defined, so as to summarize the needs as regards man-machine interaction (e.g. minimum or maximum interaction lag, minimum and maximum quantity of words, etc.). There may also still be specific rules in certain contexts, particularly in emergencies or critical situations. The categories of contexts may be static or dynamic (e.g. configurable).

The method can be implemented in a system comprising means for determining a flight context of the aircraft, said determining means comprising, in particular, logic rules, which manipulate values such as are measured by means of physical measurement. Stated otherwise, the means for determining the “flight context” comprise system or “hardware” means or physical/tangible means and/or logical means (e.g. logic rules, for example predefined). For example, the physical means comprise the avionics instrumentation in the proper sense (radars, probes, etc.) which make it possible to establish factual measurements characterizing the flight. The logic rules represent the set of processings of the information making it possible to interpret (e.g. to contextualize) the factual measurements. Certain values may correspond to several contexts and by correlation and/or computation and/or simulation, it is possible to decide between candidate “contexts”, by means of these logic rules. A variety of technologies makes it possible to implement these logic rules (formal logic, fuzzy logic, intuitionist logic, etc.).

As a function of the flight context, for example in an emergency situation, it is entirely acceptable to provide quantitatively very reduced information: the tiled panel according to the invention will be reduced or indeed closed. When the situation so allows, such as determined by the set of logic rules governing the man-machine interaction, it will on the other hand be possible to display more information: the tiled panel according to the invention will then be extended and it will be possible for additional commands and/or attributes and/or options to be proposed.

In an “automated” or “contextual” or “contextualized” embodiment, for example as a function of the flight context, the tiled panel can take certain predetermined forms.

In one embodiment combining the modes of “access on request” and of “contextual access”, some information is rendered accessible in a contextual manner by default while certain other information is accessible on demand. Various lists and conditions governing these lists can be predefined. The lists and/or conditions can be defined in configuration files which are for example read by the FMS during its initialization.

The reconfiguration of the display may be conditional, e.g. the rules can comprise tests and/or checks. The rules may take parameters of avionics and/or non-avionics type. For example, the various phases of the flight plan (takeoff, cruising or landing), including according to a finer granularity, can be associated with different configuration/reconfiguration rules. For example, the needs in terms of display during takeoff are not the same as those during the cruising regime and the display may be reconfigured accordingly.

The tests can also take into account cognitive and/or biological data (for example via the measurement of the pilot's cognitive burden and feeding back in return to an adaptation of the display; a monitoring of the pilot's biological parameters, e.g. heartbeat and perspiration inferring from the estimations of stress level may lead to the display being adapted or reconfigured in a certain manner, for example by raising or lowering screen density, etc.).

In one embodiment, the reconfiguration of the tiled display panel is “disengageable”, i.e. the pilot can decide to cancel all the adaptations of the display in progress and return rapidly to the native display mode without said reconfiguration. Exit from the reconfiguration mode may for example be effected by voice command (passphrase) and/or via an actuator (deactivation button).

Concerning the measurement of the visual density 520, various regulations are possible.

In a development, the method furthermore comprises a step consisting in measuring the visual density of the display 520.

In one embodiment, the appropriate display scale is determined as a function of readability (psychometric notion) referred to the visual density measurement displayed.

The display density may in particular be determined by an intrinsic measurement (e.g. number of pixels per unit area) and/or by an extrinsic measurement (e.g. means for acquiring external images). In one embodiment, the display density can be defined by the “readability” of the information, i.e. according to the measurement of the spacings between symbols and/or text characters displayed and the reference to a predefined psycho-visual model (i.e. thresholds or spans of thresholds).

The display density may in particular be determined by an intrinsic measurement (e.g. number of pixels per unit area, such as indicated by the internal graphics processor for example) and/or by an extrinsic measurement (e.g. a video camera or image acquisition means capturing the final rendition of the representation of the data on an EFB and/or the FMS screens, for example by measuring this number of pixels per unit area).

According to the embodiments, the “visual density” or “display density” can be measured as the number of lit or active pixels per square centimeter, and/or as the number of alphanumeric characters per unit area and/or as the number of predefined geometric patterns per unit area. The visual density can also be defined, at least partially, according to physiological criteria (model of the pilot's reading speed, etc.).

From a system point of view, image acquisition means (for example a stills camera or a video camera disposed in the cockpit) make it possible to capture at least a part of the set of visual information displayed destined for the pilot (advantageously, this video feedback will be placed on a head-up visor, smartglasses or any other facility worn by the pilot, so as to capture the pilot's subjective view).

In one embodiment, the method comprises the steps consisting in receiving a capture of the display screen by a third-party image acquisition system and in determining a visual density map of said capture.

The determination of the visual density can be done by extracting data from images (known as “scraping”). From the acquisitions of images or videos may be extracted data such as text (by OCR, Optical Character Recognition), numerical values, cursor or dial positions, etc. Extractions of data or information from audio streams are also possible (separately or in combination).

A “scraping” operation designates an operation of recovery or capture of information on a digital object, said recovery or capture not being provided for originally by the digital object. For example, this recovery of information can comprise the acquisition of one or more images and then the recognition of characters within the captured images.

The step of measuring the visual density and the adjustment step are independent in time: the steps may be performed successively or in parallel, i.e. with or without correction of a first non-optimized display of the tiled display panel (which may otherwise be temporarily hidden to the pilot). In one embodiment, the optimizations are performed upstream (the measurement of the visual density is intrinsic) and the final result is displayed. In one embodiment, the measurement of the extrinsic visual density is noted, and then corrected.

In one embodiment, the zoom or magnification level is increased (or reduced). In other embodiments, by image analysis (performed in a fixed regular manner or in a continuous manner in the case of a video capture), the density of information is estimated according to the various sub-parts of images and display adjustments are determined dynamically. For example, in the case where a display screen were to become overly “congested” (quantity of text or of graphical symbols in excess with respect to one or more predefined thresholds), the lowest-priority information is “reduced” or “condensed” or “summarized” in the form of benchmarks or of symbols selectable according to diverse modalities (placement of the interactive benchmarks on or along a graphical representation of the flight of the aircraft). Conversely, if the density of information displayed so allows, information which is reduced or condensed or summarized, for example previously, is developed or detailed or extended or magnified.

In one embodiment of the invention, the “visual density” is kept substantially constant. The flight phase or context may modulate this visual density (for example, on landing or in the critical phases of the flight, the information density is reduced).

In one embodiment, visual-rendition effects applied to one or more display tiles are triggered automatically so as to improve the readability of the displayed information.

In one embodiment, the visual-density criteria may be adapted as a function of the physical disposition of the display, i.e. depending on whether the display is situated head-up, at head-level or head-down. For example for head-down, the whole set of information will be able to be presented, whilst the information might be reduced or summarized on displays situated at head-level or head-up.

In one embodiment, in order to optimize the dimensions of the display of the panel 200, the display tiles may display only a subset of the information or commands available (e.g. the most information which is most critical or of highest priority according to the flight context). In one embodiment, the whole set of information and/or commands available may nonetheless remain accessible to the pilot, for example via scrolling operations in each tile, the selecting of sub-tabs, etc.

In one embodiment, the dimensions of the display tiles and/or the spacing between the interactive objects may be dependent on the exterior environment of the aircraft. For example, the turbulence conveying the vibratory state of the aircraft can be measured or quantized. Such turbulence impacts the reading and/or input of information. In order to decrease errors of reading and/or of input, the form (e.g. the dimensions, the number of unfolded tiles, the visual density of each of the tiles, their spatial distribution, etc.) and/or the background (e.g. the selection of the information displayed in the various tiles, their level of detail, filtering of the relevant information, etc.) can be adjusted. For example, in case of turbulence, it will be possible to display a wider panel and/or to reduce the quantity of information displayed so as to increase the spacing between the interactive elements of the display panel.

The display panel according to the invention and its variants can be implemented in or by various systems of screens.

The method can be implemented at the Navigation Display ND or on a Digital MAP (digital map displayed on a Display). The method can also be implemented at the so-called MFD screen. There is disclosed a system for implementing the steps of the method, the system comprising one or more FMD and/or ND display screens and/or an electronic flight bag EFB and/or a computing tablet. The display means can comprise means of virtual and/or augmented reality. The system can comprise means for acquiring images of the cockpit and/or a device for tracking the pilot's gaze.

The method can be implemented in a, so-called integrated, MSI (Man System Interface). Such an interface fuses the information arising from several systems (including the FMS, the RMS, the data link, or indeed even an EFB for example) on one and the same screen. An EFB that is able in particular to host software applications specially designed to automate functions such as takeoff performance computations, airplane fore/aft balance, weather, briefing, maintenance operations, information fusion (concentration of the data, visualizations) may be particularly effective.

In these MFD, EFB, ND, MSI variants, the panel may in particular comprise three zones (upper banner, tiles, details of the tiles), according to various levels of information hierarchy, affording access to the whole set of FMS functions.

There is also disclosed a computer program product, said computer program comprising code instructions making it possible to perform the steps of the method, when said program is executed on a computer.

1. A method of displaying data for the management of the flight of an aircraft comprising the steps:
receiving an indication of the selection of an object on a display screen present in the cockpit of the aircraft;
determining one or more flight commands associated with the selected object;
selecting at least one flight command from among said one or more determined flight commands;
generating a display panel comprising a plurality of display tiles, one of the tiles displaying data associated with the selected object and another tile displaying the flight command selected.

2. The method as claimed in claim 1, further comprising determining a plurality of attributes related to the flight command selected.

3. The method as claimed in claim 1, further comprising determining an aircraft flight plan revision associated with the selected command and updating the content of one or more display tiles as a function of said flight plan revision.

4. The method as claimed in claim 1, further comprising modifying the display of at least one attribute associated with the flight command selected as a function of the earlier selection of a flight command.

5. The method as claimed in claim 1, further comprising modifying the flight command selected as a function of the earlier selection of a flight command.

6. The method as claimed in claim 1, the display tiles being displayed in an adjacent manner in space and/or in a progressive manner over time.

7. The method as claimed in claim 1, further comprising adjusting the shape and/or the content of the tiled display panel as a function of predefined display rules.

8. The method as claimed in claim 7, the display rules being determined as a function of the aircraft's flight context.

9. The method as claimed in claim 7, the display rules being determined as a function of the measured visual density of display.

10. The method as claimed in claim 1, further comprising displaying the display panel on one or more screens in the cockpit of the aircraft.

11. The method as claimed in claim 1, the adjusting of the display or the display of the tiled display panel being deactivated on demand.

12. The method as claimed in claim 1, further comprising receiving a message instructing that a display tile be closed or maximized or reduced.

13. A computer program product, said computer program comprising code instructions making it possible to perform the steps of the method as claimed in claim 1, when said program is executed on a computer.

14. A system comprising means for implementing the steps of the method as claimed in claim 1.

15. The system as claimed in claim 14 comprising one or more FMD and/or ND display screens and/or an electronic flight bag EFB and/or a computing tablet.

16. The system as claimed in claim 14 comprising means of virtual and/or augmented reality.

17. The system as claimed in claim 14, comprising means for acquiring images of the cockpit and/or a device for tracking the pilot's gaze.
